(19) United States
(12) Patent Application Publication
(10) Pub. No.: US 2024/0147180 A1
(43) Pub. Date: May 2, 2024

(54) SENSOR DATA PREDICTION

(71) Applicant: DOLBY LABORATORIES LICENSING CORPORATION, San Francisco, CA (US)

(72) Inventors: Qi Huang, Beijing (CN); Baoli Yan, Beijing (CN); Zhifang Liu, Beijing (CN); Libin Luo, Beijing (CN)

(73) Assignee: DOLBY LABORATORIES LICENSING CORPORATION, San Francisco, CA (US)

(21) Appl. No.: 18/280,314

(22) PCT Filed: Mar. 18, 2022
(86) PCT No.: PCT/US2022/020840

§ 371 Date: Sep. 5, 2023

Related U.S. Application Data
(60) Provisional application No. 63/177,441, filed on Apr. 21, 2021.

(30) Foreign Application Priority Data
Mar. 19, 2021 (WO) PCT/CN2021/081747

(51) Int. Cl. H04S 7/00; H04R 1/10

(52) U.S. Cl. CPC H04S 7/304; H04R 1/10

(57) ABSTRACT

Systems, methods, and computer program products implementing a sensor data prediction algorithm are disclosed. An example method comprises receiving motion data representing motions of a head-mounted listening device; transforming the motion data into quaternion domain; predicting, by one or more processors, future motions of the head-mounted listening device, the predicting including creating angular acceleration data from the transformed motion data and applying one or more smoothing filters to the angular acceleration data, the predicted future motions including rotation angles around corresponding axes in the quaternion domain; and providing the predicted future motions of the head-mounted listening device to a processor for adjusting a sound field presented by the listening device such that the sound field follows predicted movements of the head-mounted listening device.

### CROSS-REFERENCE TO RELATED APPLICATIONS

This application claims priority of International PCT Application No. PCT/CN2021/081747 filed Mar. 19, 2021 and U.S. Provisional Application No. 63/177,441, filed Apr. 21, 2021, each of which is hereby incorporated by reference in its entirety.

### FIELD OF THE INVENTION

The present disclosure relates to a method of audio processing.

### BACKGROUND

When using wireless headphone technology, sound is conventionally streamed, e.g. using Bluetooth technology, from a device comprising a processor such as a smartphone or a computer. Modern wireless headphones comprise different types of sensors that may e.g. be used to monitor head movements of a user. In order to adapt the sound streamed from a device to the position and angle of the head, sensors in the headphones send data to the device, which is used to adapt the sound sent to the headphones.

### SUMMARY

The present disclosure is based on an understanding that sending information such as sound data or sensor data between the headphones and the device takes time, which introduces transfer latency into said adaptation of the sound based on the position and angle of the head. It would thus be desirable to provide a method that compensates for transfer latency of sensor data from headphones or similar head-mounted listening devices.

According to an aspect of the present disclosure, a method of audio processing is provided that comprises predicting future movements of a head of a user based on a history of motion data. By providing such a prediction to a processor, a sound field presented by the listening device is adjusted to compensate for future movements, thereby improving a listening experience for the user.

The prediction comprises applying one or more filters to a history of motion data. This may reduce sensor signal noise and enable a more accurate prediction.

Motion data representing motion of a user's head is processed in quaternion domain. This domain provides for an additional degree of freedom compared to more traditional sensor outputs such as Euler angles or Cartesian coordinates. By being able to express e.g. both acceleration and velocity in a single number system, the processing of the motion data, including the prediction, may be made more efficient and accurate. Additionally, Gimbal lock is prevented by not using Euler angles. As generally known, a Gimbal lock is when a degree of freedom is lost because two gimbals (rotational axes) along different Euler axes align into being parallel, thereby “locking” the system into a degenerate two-dimensional space.

This specification discloses a sensor data prediction algorithm to reduce the impact of Bluetooth latency and improve headphone listening experience. This sensor data prediction algorithm is based on history information to estimate the future motion data for reducing potential transfer latency, in this way it is different to sensor data fusion. The algorithm is not used to predict the user's motion patterns such as walking, running, and sitting etc. It works in the quaternion domain in order to predict the rotation angles around corresponding axes through angular velocity and acceleration. The prediction period is targeted to more than ten times of the sensor data period. This means for a typical inertial measurement unit (IMU) mounted on Bluetooth earbud, for which the sensor data rate is about one hundred hertz, the predictive period target will be about 100 ms. With the help of this algorithm, a processor is enabled to alleviate data transfer latency issues and improve the user hearing experience.

Head 3D rotation is usually nonstationary, which means that the properties of a statistical function describing how directions of the head are distributed may change with time. However, in the present scenario the head moves relatively slowly compared with the IMU sensor data update rate (typical sensor data rate for head tracking is about one hundred hertz, and the angular velocity is less than 0.5 degree/millisecond). Therefore, it's technically useful to model it as a piecewise linear system. In other words, the head 3D rotation may be modelled as a linear system in the predictive period of about 100 ms. Based on this assumption, a prediction algorithm according to this specification works well.

During sensor fusion processing, the input may be accelerometer and/or gyroscope sensor data. The processing data format may be transformed into quaternion format (w, x, y, z) because in this domain there will not be any Gimbal lock issue as with in Euler angle domain. The proposed method utilizes the properties of 3D rotation data in quaternion representation. From the physical point of view quaternion data represent a 3D rigid object movement as a specific angle around a specific axis. If the angular velocity is predicted and modified through estimated acceleration, predicted 3D rotation angles may be achieved by integration.

### DRAWINGS

By way of example, embodiments of the present invention will now be described with reference to the accompanying drawings, in which:

FIG. 1 illustrates an embodiment of a method of audio processing;

FIG. 2 illustrates an embodiment of a filter for use in the method for audio processing;

FIG. 3 illustrates an embodiment of a sliding window angular velocity averaging unit for use in the method for audio processing; and

FIG. 4 is a flowchart of an embodiment of a method of audio processing.

### DETAILED DESCRIPTION

In the following, a method of audio processing is disclosed. The method is shown by way of example as implemented by a head-mounted listening device (e.g. a headphone or earbuds) comprising inertial measurement units (IMU), however other embodiments are possible within the scope of the appended claims of this specification.

As an example of a use scenario for the method for audio processing, a device (e.g. a smartphone or computer) is streaming a virtual soundscape to a user wearing a head-mounted listening device. The virtual soundscape is intended to provide a consistent 3D soundscape relative to the user. The streaming device receives motion data from IMUs of the head-mounted listening device in order to determine an orientation of the user's head in relation to the virtual 3D soundscape and adapts the stream accordingly.

Sending motion data from the head-mounted listening device to the streaming device and streaming the virtual soundscape from the streaming device to the head-mounted listening device takes time, which introduces transfer latency into this adaption of the virtual soundscape to the orientation the user's head. To this end, the disclosed method of audio processing enables a prediction of the motion of the user's head to e.g. predict future angular rotation and thereby compensate for the latency.

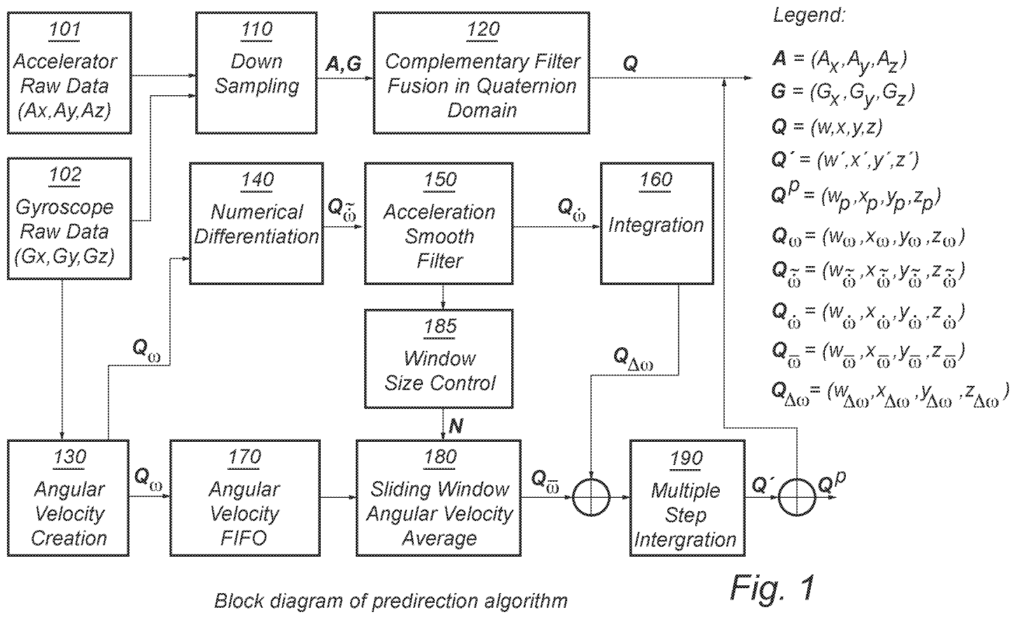

FIG. 1 illustrates the principal layout of a prediction algorithm, and thus represents an embodiment of a method of audio processing. In the figure, raw motion data is filtered in the process along the top of the figure, and processed to predict future motion of a head of a user in the process along the bottom of the figure. In the figure, six degrees of freedom (6-DoF) IMU sensors (include Accelerator and Gyroscope) would create raw data as the input to the algorithm. In other words, one or more sensors (e.g. an accelerator or gyroscope) of a head-mounted listening device output motion data representing motions of a user's head. This motion data may e.g. be accelerator raw data and/or gyroscope raw data in 6-DoF (Ax, Ay, Az from an accelerator and Gx, Gy, Gz from a gyroscope).

This motion data is received by one or more processors, that may be comprised in the listening device or another device such as a smartphone or computer. After down sampling, the raw data will be fed into complementary filter to be fused in the quaternion domain. In other words, a filter may be used to convert the 6-DoF raw motion data into quaternion domain (w, x, y, z). The fused data will be the base to the prediction quaternion. In other words, this converted raw motion data Q is used to create the predicted future head position and to verify and/or correct gyroscope drift that may affect the prediction for future head movement in the process along the bottom of the figure.

In the process along the bottom of the figure, gyroscope raw data is used to predict future head movement by calculating an angular velocity of the head. The prediction period is targeted to more than ten times the sensor data period. For a typical IMU comprised in a typical head-mounted listening device, the sensor data rate is about 100 Hz. The targeted predictive period will then be about 100 ms.

Head 3D rotation is usually nonstationary, which means that the properties of the statistical function may change with time. However, in the present scenario the head rotation moves relatively slow compared with the IMU sensor data update rate (the typical angular velocity of the head is less than 0.5 degree/millisecond, which is slow compared to the 100 Hz sensor data rate). Therefore, the head 3D rotation may be modelled as a linear system in the predictive period of about 100 ms.

Firstly, gyroscope data should be converted from the body frame to global frame. The angular velocity will be calculated in this module. Then a FIFO buffer will hold a reasonable length of history quaternion data and calculate their corresponding angular velocity, further based on the velocity to calculate angular acceleration through differential process. In other words, the raw motion data from the gyroscope is converted to the quaternion domain according to methods known in the art. The raw motion data from the gyroscope may e.g. be angular velocity of the head (or similarly, of the head-mounted listening device) in Euler angle domain or cartesian domain. An angular velocity of the head (or similarly, of the head-mounted listening device) is calculated using converted raw motion data from the gyroscope, i.e. by using transformed motion data. The calculated angular velocity in the quaternion domain is stored in a first in first out (FIFO) buffer memory. The angular velocity in the quaternion domain Q_{ω} may be calculated by the equation:

Q_{ω}=½Qₜ₋₁⊗G_{ω},

where Qₜ₋₁ is the previous estimate of rotation, and where the initial value may be set to Q₀=(1,0,0,0). In other words, Qₜ₋₁ is the previously calculated angular velocity, i.e. Q_{ω} that was calculated based on the previous angular velocity and raw data, that may be stored in the buffer memory.

G_{ω}=(0, Gₓ, G_{y}, G_{z}) is the gyroscope raw data, i.e. the converted raw motion data from the gyroscope in the quaternion domain. The motion data of the gyroscope is angular velocity in this case, though other sensors and motion data may be used in other embodiments. ⊗ is the quaternion cross multiplication operator.

There's no direct angular acceleration data available, so the angular acceleration is created through numerical differentiation. In other words, the gyroscope raw data does not comprise angular acceleration and this data is instead calculated through numerical differentiation. The angular acceleration Q_{\dot{\tilde{ω}}} may be calculated by the equation:

$${Q}_{\tilde{\dot{ω}}} ( t ) = \frac{{Q}_{ω} ( t ) - {Q}_{ω} ( t - 1 )}{T} ,$$

where Q_{ω}(t) is the angular velocity at time t, t−1 is the previous time to t, i.e. the immediately preceding time instance where Q_{ω} has a value, and T is the sensor data sampling period, i.e. around 10 ms.

During the angular acceleration creation process, the noise in the velocity data may be amplified and make the result difficult to use directly. Thus, any noise in the velocity data may be amplified by the above calculation as the denominator is typically much smaller than 1 s. An acceleration smooth filter may added to overcome this issue which can be a RLSN (Recursive Linear Smoothed Newton) filter or TV (Total Variation regularization) filter. In other words, a smoothing filter is used to smooth out any such amplified noise in the angular acceleration data.

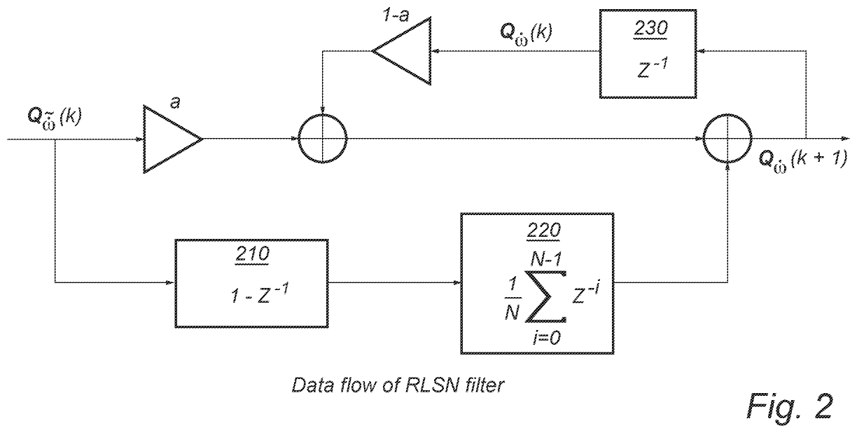

The output of this module is the smoothed angular acceleration data Q_{\dot{ω}}. An example RLSN filter will be disclosed in more detail with reference to FIG. 2.

The smoothed angular acceleration data is then integrated to calculate an angular velocity changing value that is used to predict the future angular direction of the head. The integration module will integrate the angular acceleration to create an angular velocity changing value Q_{Δω}:

Q_{Δω}=∫Q_{\dot{ω}}dt

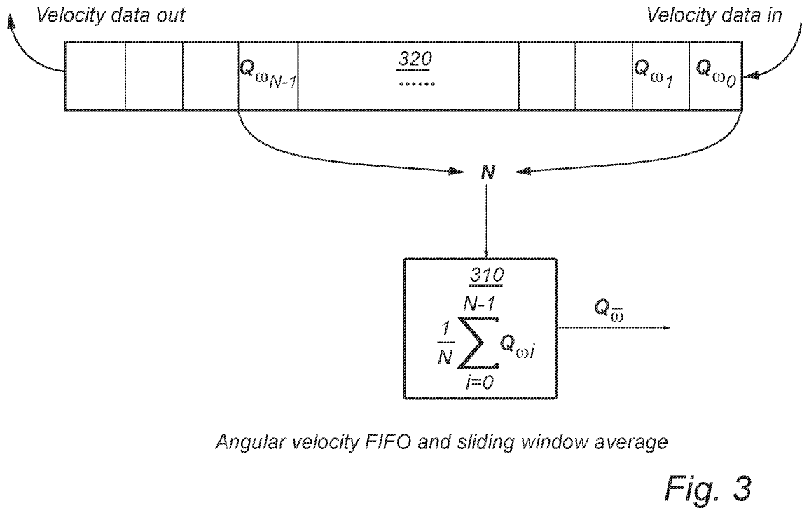

Due to the mechanical inertia that smoothens the head movements, predicted velocity should be smoothed by averaging the history velocity data. A sliding window average module is designed for predicting the basic angular velocity. In other words, real head movement has mechanical inertia that smooths the motion. In order to incorporate this inertia into the calculated angular velocity, the historical converted raw angular velocity data stored in the buffer memory is used in a sliding window average calculation to create an average angular velocity Q_{ω̅}. The sliding window size was controlled by acceleration value which can be used to balance between the predicted velocity smoothness and the quick response ability. In other words, the size of the sliding window used in the sliding window average calculation is inversely proportional to the calculated angular acceleration in order to balance between a quick reaction that may be beneficial for a high angular acceleration and a more statistically significant average that results from using a longer sliding window size. The sliding window average calculation will be disclosed in more detail with reference to FIG. 3.

The angular velocity is assumed either constant or linearly changing, it would be updated by acceleration data repeatedly. In other words, because of the relatively slow typical angular velocity of a head compared to a typical IMU sensor data update rate as previously discussed, the angular velocity of the head can be modelled to be either constant or linearly changing. After a multiple step integration, combined with the fused quaternion data, the predicted 3D rotation angle will be created in the quaternion domain. In other words, the angular velocity changing value Q_{Δω} and the average angular velocity Q_{ω̅} are added together and integrated using different time-integrators for different parts of the integration period in the multiple step integration block to create a predicted angular changing value Q′. This predicted angular changing value Q′ is then combined with the converted raw motion data Q created in the process along the top of the figure to create a predicted 3D rotation angle in the quaternion domain Q^{p}.

Because the predict part models worked at higher data rate domain compared with data fusion part, the multiple step integration module is used to match the data processing timing. In other words, the process along the bottom of the figure works in a different data rate domain compared to the process along the top of the figure, and therefore multiple step integration using different time-integrators for different parts of the integration period may be used to match the data rate of Q′ with Q. After integration and combining fused data, predicted angles will be generated in quaternion domain:

Q′=∫(Q_{Δω}+Q_{ω̅})dt

Q^{p}=Q+Q′

As the movement is typically smooth in a head tracking scenario, it can be assumed that the changing of angle is piecewise linearized. With the help of angular acceleration to predict future velocity, this will make it possible to give a good estimation of the most likely angles in the prediction period. In other words, the resulting predicted 3D rotation angle in the quaternion domain Q^{p} enables a reliable and accurate prediction of the future angle of the head of the user.

In FIG. 2, an embodiment of an RLSN filter is illustrated. This module may decrease any amplified sensor signal noise during the angular acceleration creation process.

In FIG. 2, a is a weighting factor, that may e.g. have a value of 0.02 or 0.03. Thus, the weighting factor a is used as a recursive weight and may generally be between 0.01 and 0.05. N is a length of a moving average, and may e.g. have a value of 16 or 32. In other words, N is a value used for the length of a moving average operation, which may be between 8 and 64. k is an index for the calculated angular acceleration, where subsequent indices correspond to sequential measurements by the IMU sensor. Z is the input into the operator illustrated as a box.

The RLSN filter acts as a low-pass filter with reduced delay compared to conventional low-pass filters. Because the acceleration is modelled as being linear, the first derivative calculated in the filter is modelled as a constant. Therefore, it can be filtered along the bottom process of FIG. 2 by a moving averager without delaying the signal in steady state.

Additional low-pass filtering is realized along the top process of FIG. 2 by a recursive structure that implements a weighting average of the input by its smoothed value.

Alternative implementations of an RLSN filter would also be possible within the scope of the appended claims. Additionally, other smoothing filters such as TV filters may be used in addition to or replacing the RLSN filter as described.

FIG. 3 illustrates the process in the boxes “Angular Velocity FIFO and Sliding Window Angular Velocity Average” in FIG. 1. The logic of this module is based on the acceleration data to choose the average sliding window size. In other words, the sliding window average process uses the calculated angular acceleration data as input to control the average window size to be inversely proportional to the value of the angular acceleration. If the acceleration is large, that may mean that a relatively large velocity change may happen, and the average window size will then be set to small. In other words, the inverse proportionality is used because a relatively large acceleration may result in a relatively large change in velocity, which benefits from being modeled with a relatively small average window size.

In FIG. 3, N represents the window size of the sliding window average process. The process uses the N latest data points that are available for angular velocity from the buffer memory and calculates an average value Q_{ω̅} for the angular velocity.

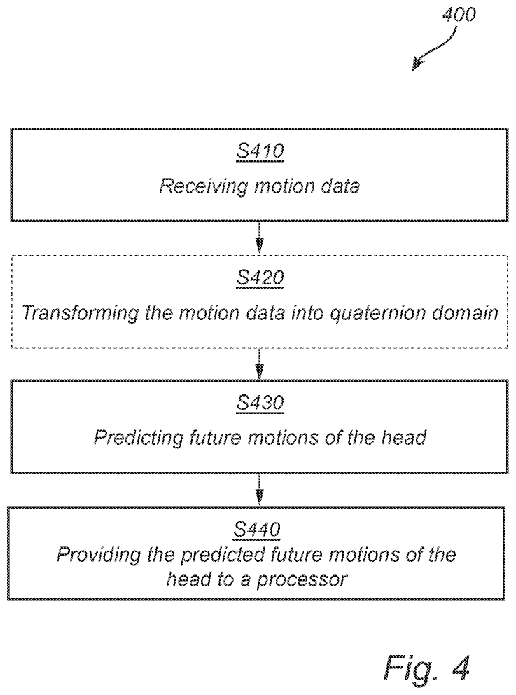

FIG. 4 shows a flowchart of a method of audio processing. The method comprises a number of steps that may be performed by a processor, e.g. of a streaming device.

The first step of the method comprises receiving motion data. The step comprises receiving, from a head-mounted listening device, motion data representing motions of a user's head. The motion data may be in the quaternion domain or not.

If the motion data is not received in the quaternion domain, the next step comprises transforming the received motion data into quaternion domain.

The method further comprises predicting future motions of the head. This step comprises creating angular acceleration data from the transformed motion data and applying one or more smoothing filters to the angular acceleration data, the predicted future motions including rotation angles around corresponding axes in the quaternion domain.

The predicting step may further comprise creating angular velocity data from the transformed motion data, which may comprise using a previously created angular velocity data and transformed motion data corresponding to angular velocity data.

The predicting step may further comprise creating angular acceleration data by performing numerical differentiation on angular velocity data.

The predicting step may further comprise applying a Recursive Linear Smoothed Newton filter to the angular acceleration data. This reduces noise in the created angular acceleration data.

The predicting step may further comprise determining a sliding window average of an angular velocity from a history of the angular velocity. This may be used to adapt the prediction for inertia of the head.

A size of the sliding window may be determined by the angular acceleration data. Thereby, the sliding window average may be adaptive to the acceleration of the head and be more reliable.

The method further comprises providing the predicted future motions of the head to a processor, e.g. of a streaming device. The processor may then adjust a sound field presented by the listening device such that the sound field follows predicted movements of the head. Thereby, transfer latency may be reduced.

Aspects of the systems described herein may be implemented in an appropriate computer-based sound processing network environment for processing digital or digitized audio files. Portions of the adaptive audio system may include one or more networks that comprise any desired number of individual machines, including one or more routers (not shown) that serve to buffer and route the data transmitted among the computers. Such a network may be built on various different network protocols, and may be the Internet, a Wide Area Network (WAN), a Local Area Network (LAN), or any combination thereof.

One or more of the components, blocks, processes or other functional components may be implemented through a computer program that controls execution of a processor-based computing device of the system. It should also be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, physical (non-transitory), non-volatile storage media in various forms, such as optical, magnetic or semiconductor storage media.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

### Enumerated Exemplary Embodiments

The invention may be embodied in any of the forms described herein, including, but not limited to the following Enumerated Example Embodiments (EEEs) which describe structure, features, and functionality of some portions of the present invention.

EEE1. A method of audio processing, comprising:
receiving motion data representing motions of a head-mounted listening device;
transforming the motion data into quaternion domain;
predicting, by one or more processors, future motions of the head-mounted listening device, the predicting including creating angular acceleration data from the transformed motion data and applying one or more smoothing filters to the angular acceleration data, the predicted future motions including rotation angles around corresponding axes in the quaternion domain; and
providing the predicted future motions of the head-mounted listening device to a processor for adjusting a sound field presented by the listening device such that the sound field follows predicted movements of the head-mounted listening device.

EEE2. The method of EEE1, wherein the predicting comprises applying a Recursive Linear Smoothed Newton filter to the angular acceleration data.

EEE3. The method of EEE1 or EEE2, wherein the predicting comprises creating angular velocity data from the transformed motion data.

EEE4. The method of EEE3, wherein creating angular velocity data comprises using a previously created angular velocity data and transformed motion data corresponding to angular velocity data.

EEE5. The method of EEE3 or EEE4, wherein creating angular acceleration data comprises using numerical differentiation on the created angular velocity data.

EEE6. The method of any one of EEE1-EEE5, wherein the predicting comprises determining a sliding window average of the angular velocity from a history of the created angular velocity.

EEE7. The method of EEE6, wherein a size of the sliding window is determined by the angular acceleration data.

EEE8. The method of any one of EEE1-EEE7, wherein the angular acceleration data is integrated to create an angular velocity changing value.

EEE9. The method of any one of EEE1-EEE8, wherein the head-mounted listening device includes a plurality of earbuds wirelessly connected to a playing device.

EEE10. The method of any one of EEE1-EEE9, wherein the predicting and providing steps are performed by one or more processors of a device providing the sound field to the head-mounted listening device.

EEE11. The method of EEE10, wherein the receiving and transforming steps are further performed by one or more processors of the device providing the sound field to the head-mounted listening device.

EEE12. The method of EEE10, wherein the receiving and transforming steps are performed by one or more processors of the head-mounted listening device.

EEE13. A system comprising:
one or more processors; and
a non-transitory computer-readable medium storing instructions that, upon execution by the one or more processors, cause the one or more processors to perform the method of any one of any one of EEE1-EEE12.

EEE14. A non-transitory computer-readable medium storing instructions that, upon execution by one or more processors, cause the one or more processors to perform the method of any one of EEE1-EEE12.

1. A method of audio processing, comprising:
receiving motion data representing motions of a head-mounted listening device;
transforming the motion data into quaternion domain;
predicting, by one or more processors, future motions of the head-mounted listening device, the predicting including creating angular acceleration data from the transformed motion data and applying one or more smoothing filters to the angular acceleration data, the predicted future motions including rotation angles around corresponding axes in the quaternion domain; and
providing the predicted future motions of the head-mounted listening device to a processor for adjusting a sound field presented by the listening device such that the sound field follows predicted movements of the head-mounted listening device.

2. The method of claim 1, wherein the predicting comprises applying a Recursive Linear Smoothed Newton filter to the angular acceleration data.

3. The method of claim 1, wherein the predicting comprises creating angular velocity data from the transformed motion data.

4. The method of claim 3, wherein creating angular velocity data comprises using a previously created angular velocity data and transformed motion data corresponding to angular velocity data.

5. The method of claim 3, wherein creating angular acceleration data comprises using numerical differentiation on the created angular velocity data.

6. The method of claim 3, wherein the predicting comprises determining a sliding window average of the angular velocity from a history of the created angular velocity.

7. The method of claim 6, wherein a size of the sliding window is determined by the angular acceleration data.

8. The method of claim 1, wherein the angular acceleration data is integrated to create an angular velocity changing value.

9. The method of claim 1, wherein the head-mounted listening device includes a plurality of earbuds wirelessly connected to a playing device.

10. The method of claim 1, wherein the predicting and providing steps are performed by one or more processors of a device providing the sound field to the head-mounted listening device.

11. The method of claim 10, wherein the receiving and transforming steps are further performed by one or more processors of the device providing the sound field to the head-mounted listening device.

12. The method of claim 10, wherein the receiving and transforming steps are performed by one or more processors of the head-mounted listening device.

13. A system comprising:
one or more processors; and
a non-transitory computer-readable medium storing instructions that, upon execution by the one or more processors, cause the one or more processors to perform the method of claim 1.

14. A non-transitory computer-readable medium storing instructions that, upon execution by one or more processors, cause the one or more processors to perform the method of claim 1.
